(19) United States
(12) Patent Application Publication
(10) Pub. No.: US 2026/0036155 A1
(43) Pub. Date: Feb. 5, 2026

(54) MODULAR LIGHT POLE ASSEMBLY AND METHOD OF ASSEMBLING A MODULAR LIGHT POLE

(71) Applicant: Energy Light LLC, Lake Zurich, IL (US)

(72) Inventors: Sami Ozgen, Barrington, IL (US); Mikhail Altman, Buffalo Grove, IL (US)

(21) Appl. No.: 19/282,468

(22) Filed: Jul. 28, 2025

Related U.S. Application Data
(60) Provisional application No. 63/677,116, filed on Jul. 30, 2024.

(51) Int. Cl. F16B 7/18; E04H 12/08

(52) U.S. Cl. CPC F16B 7/182; E04H 12/08

(57) ABSTRACT

A light pole assembly, and a method of assembling a light pole assembly that facilitates securement of multiple light pole segments. The light pole assembly includes a first pole shaft, a second pole shaft, and a mounting connector. The mounting connector includes an internal rib extending from an internal surface of the mounting connector.

### RELATED APPLICATIONS

This application claims the benefit of U.S. Provisional Patent Application No. 63/677,116, filed Jul. 30, 2024, the entire contents of which are incorporated herein by reference.

### FIELD OF THE DISCLOSURE

This disclosure relates generally to a modular light pole assembly, and more specifically, a modular light pole assemblies and methods of assembling modular light pole assemblies that include a mounting connector having a longitudinal rib.

### DESCRIPTION OF THE PRIOR ART

Light poles vary in length, often between 8 and 20 feet, with lengths of 12 feet, 16 feet, and 20 feet being typical. The length of the poles poses a challenge to shipping them to a job site for installation. Prior solutions have been proposed to provide telescoping poles or segmented poles that are spliced together at an installation site. Current modular poles are difficult to assemble and not completely rigid until fully secured with fasteners. Telescoping solutions require nesting pole segments, such that each successively-lower pole segment must be larger than the previous pole segment, resulting in a lower-most pole segment occupying larger-than-optimal dimensions.

There is a need for an easy-to-assemble modular light pole that can be shipped in segments of uniform length and width, and which can be assembled at an installation site, the modular light pole assembly being strong and light weight.

### SUMMARY

In a first example, a light pole assembly includes a first pole shaft having a first pole shaft wall and a first opening configured to receive a first fastener; a second pole shaft having a second pole shaft wall and a second opening configured to receive a second fastener; and a mounting connector including a connecting wall having a first end and a second end. The connecting wall is symmetrical about a longitudinal axis and includes a first connecting opening configured to receive the first fastener and a second connecting opening configured to receive the second fastener. A first longitudinal rib extends from an inner surface of the mounting connector and along the longitudinal axis of the mounting connector. The first longitudinal rib extends across the first connecting opening and the second connecting opening. The first connecting opening and the second connecting opening extend through the first longitudinal rib, thereby forming a first through bore that extends from an outer surface of the connecting wall to an inner surface of the first longitudinal rib. The first pole shaft and the second pole shaft have substantially the same cross-sectional dimensions, and the mounting connector has smaller cross-sectional dimensions at the first end and at the second end than the first pole shaft and the second pole shaft such that the first end of the mounting connector is sized to be inserted at least partially within the first pole shaft and the second end of the mounting connector is sized to be inserted at least partially within the second pole shaft.

The above example of a light pole assembly may further include any one or more of the following optional forms.

In one optional form, the first fastener extends at least partially through the first opening, through the first connecting opening, and through the first longitudinal rib.

In another optional form, a second fastener extends at least partially through the second opening, through the second connecting opening, and through the first longitudinal rib.

In yet another optional form, a second longitudinal rib extends from an inner surface of the mounting connector and along the longitudinal axis of the mounting connector.

In yet another optional form, the first longitudinal rib and the second longitudinal rib are separated by about 180 degrees around a perimeter of the connecting wall.

In yet another optional form, a third longitudinal rib extends from an inner surface of the mounting connector and along the longitudinal axis of the mounting connector.

In yet another optional form, the first longitudinal rib, the second longitudinal rib, and the third longitudinal rib are separated from one another by about 120 degrees around a perimeter of the connecting wall.

In yet another optional form, the second longitudinal rib and the third longitudinal rib each comprise a plurality of openings each opening of the plurality of openings being configured to receive a fastener.

In yet another optional form, the first longitudinal rib has a thickness that is greater than a thickness of the connecting wall.

In yet another optional form, the first longitudinal rib is not continuous and includes one or more breaks therein along the longitudinal axis.

In yet another optional form, the first pole shaft, the second pole shaft, and the mounting connector each have substantially circular cross-sectional shapes.

In yet another optional form, the first pole shaft, the second pole shaft, and the mounting connector each have substantially square cross-sectional shapes.

In yet another optional form, the first pole shaft, the second pole shaft, and the mounting connector each comprise aluminum.

In yet another optional form, the first pole shaft, the second pole shaft, and the mounting connector each comprise steel.

In yet another optional form, an exterior ledge extends outward from an outer surface of the connecting wall.

In yet another optional form, the exterior ledge has a thickness that is less than a width of the connecting wall,

In yet another optional form, the ledge is positioned approximately half way between the first end of the mounting connector and the second end of the mounting connector.

In a second example, a method for assembling a light pole assembly includes providing a first pole shaft having a first pole shaft wall and a first opening configured to receive a first fastener; providing a second pole shaft having a second pole shaft wall and a second opening configured to receive a second fastener; and providing a mounting connector including a connecting wall having a first end and a second end, the connecting wall being symmetrical about a longitudinal axis. The connecting wall includes a first connecting opening configured to receive the first fastener and a second connecting opening configured to receive the second fastener. The mounting connector further includes a first longitudinal rib extending from an inner surface of the mounting connector and along the longitudinal axis of the mounting connector. The first longitudinal rib extends across the first connecting opening and the second connecting opening. The first connecting opening and the second connecting opening extend through the first longitudinal rib, thereby forming a first through bore that extends from an outer surface of the connecting wall to an inner surface of the first longitudinal rib. A first end of the mounting connector is at least partially inserted into an open end of the first pole shaft. A second end of the mounting connector is at least partially inserted into an open end of the second pole shaft. A first fastener is inserted through the first opening, through the first connecting opening, and through the first longitudinal rib. A second fastener is inserted through the second opening, through the second connecting opening, and through the first longitudinal rib.

The above example of a method for assembling a light pole assembly may further include any one or more of the following optional forms.

In one optional form, the mounting connector includes a second longitudinal rib.

In yet another optional form, the first longitudinal rib and the second longitudinal rib are separated by about 180 degrees around a perimeter of the connecting wall.

In yet another optional form, the mounting connector includes a third longitudinal rib.

In yet another optional form, the first longitudinal rib, the second longitudinal rib, and the third longitudinal rib are separated from one another by about 120 degrees around a perimeter of the connecting wall.

In yet another optional form, the second longitudinal rib and the third longitudinal rib each comprise a plurality of openings each opening of the plurality of openings being configured to receive a fastener.

In yet another optional form, the first longitudinal rib has a thickness that is greater than a thickness of the connecting wall.

In yet another optional form, the first longitudinal rib is not continuous and includes one or more breaks therein along the longitudinal axis.

In yet another optional form, the first end of the mounting connector is inserted into the open end of the first pole shaft until an external ledge on the mounting connector contacts the open end of the first pole shaft.

In yet another optional form, the second end of the mounting connector is inserted into the open end of the second pole shaft until the external ledge on the mounting connector contacts the open end of the second pole shaft.

### BRIEF DESCRIPTION OF THE DRAWINGS

FIG. 1 is a front, partially exploded perspective view of a light pole assembly;

FIG. 2 is a top perspective view of a mounting connector of the light pole assembly of FIG. 1;

FIG. 3 is a side perspective view of the mounting connector of FIG. 2;

FIG. 4 is an end perspective view of the mounting connector of FIG. 2;

FIG. 5 is a side view of the mounting connector of FIG. 2;

FIG. 6 is a top view of the mounting connector of FIG. 2;

FIG. 7 is side cross-sectional view of the mounting connector of FIG. 2;

FIG. 8 is another side cross-sectional view of the mounting connector of FIG. 2;

FIG. 9 is a side perspective cross-sectional view of the mounting connector of FIG. 2;

FIG. 10 is another side perspective cross-sectional view of the mounting connector of FIG. 2;

FIG. 11 is yet another side perspective cross-sectional view of the mounting connector of FIG. 2;

FIG. 12 is a side perspective view of an alternate embodiment of a mounting connector;

FIG. 13 is a side cross-sectional view of the mounting connector of FIG. 12;

FIG. 14 is a side perspective cross-sectional view of the mounting connector of FIG. 12;

FIG. 15 is a top cross-sectional view of the mounting connector of FIG. 12; and

FIG. 16 is a partially exploded perspective view of an alternate embodiment of a light pole assembly.

### DETAILED DESCRIPTION

The light pole assemblies described herein may be advantageously easily and quickly assembled in the field with minimal tools. Moreover, the light pole assemblies described herein provide a more secure connection between light pole segments. Still further, the light pole assemblies described herein are stronger than traditional light pole assemblies and also have reduced vibration characteristics relative to traditional light pole assemblies due to the internal structures of the mounting connector interrupting the natural harmonic resonance of the assembled light pole.

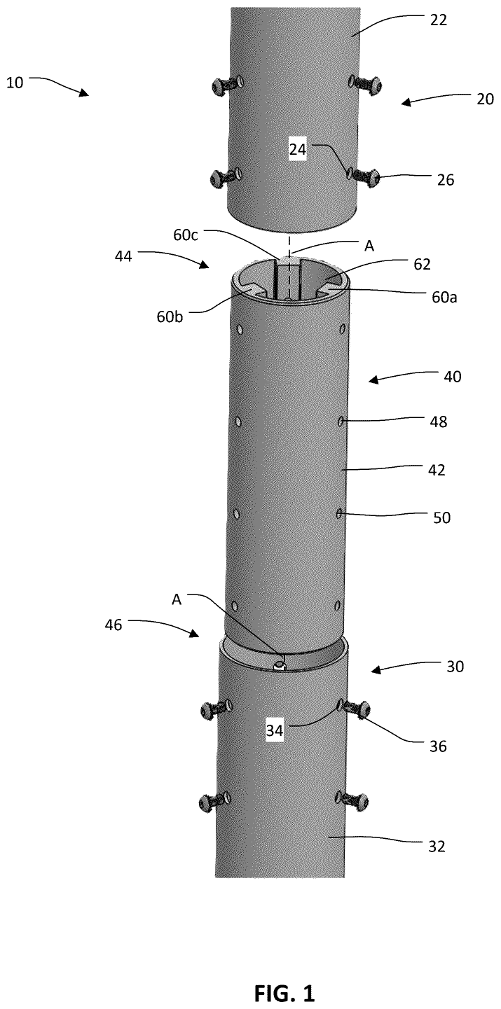

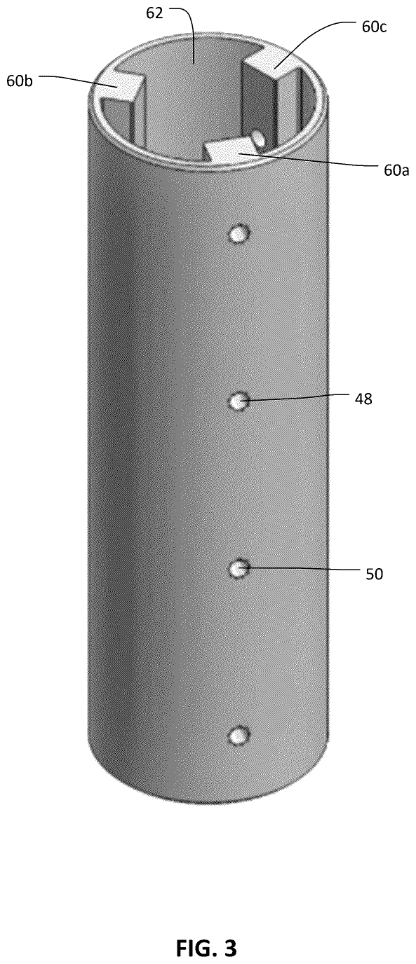

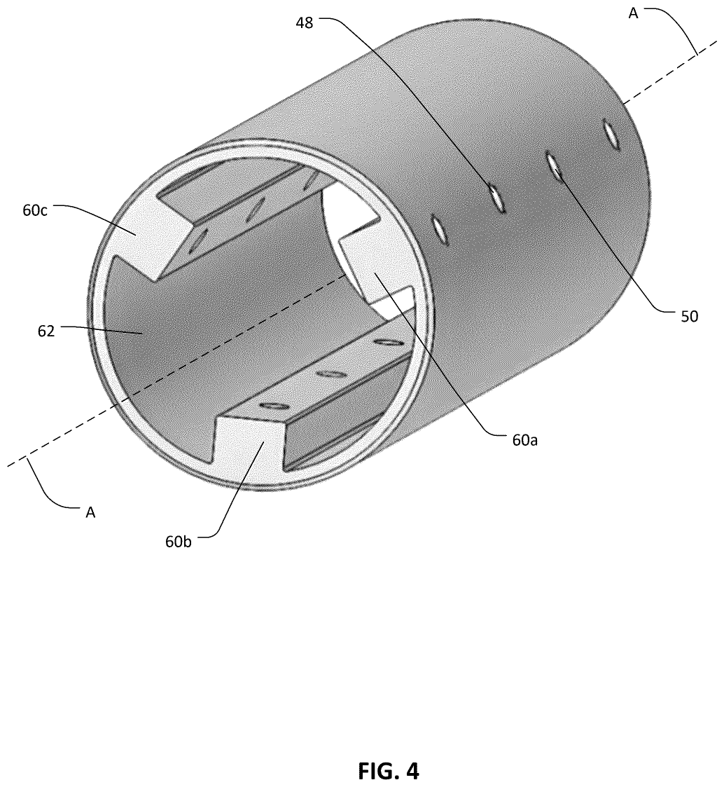

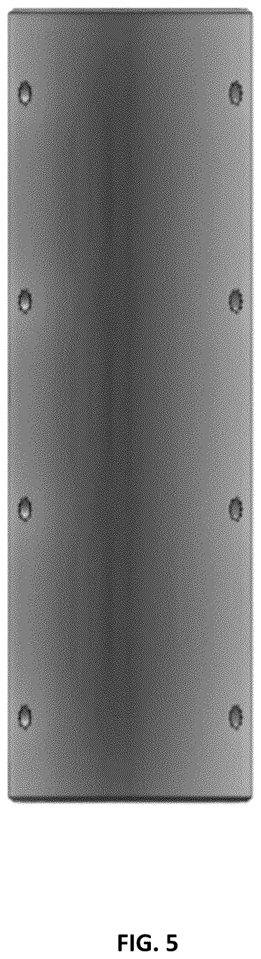

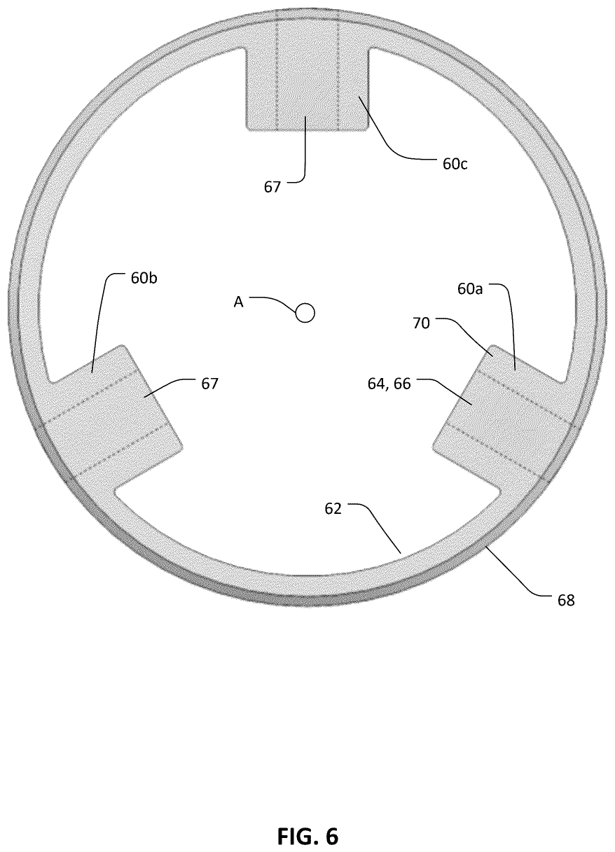

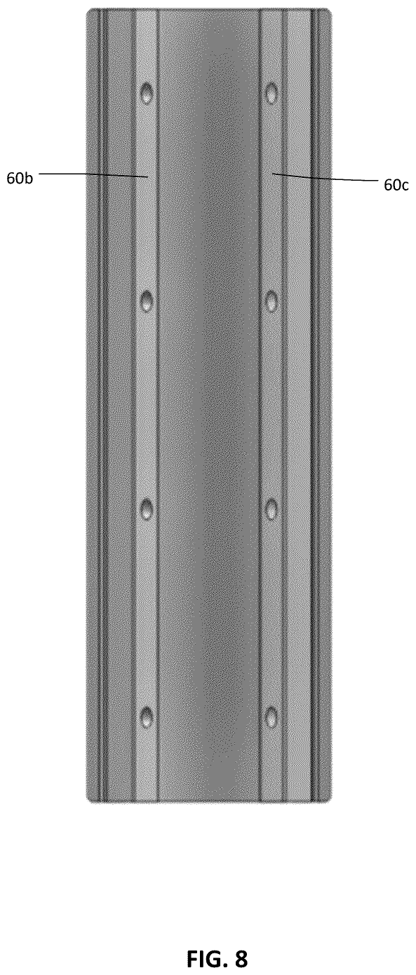

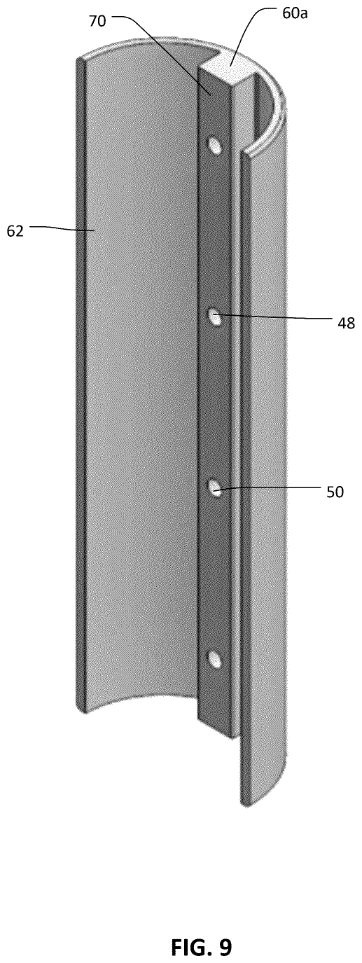

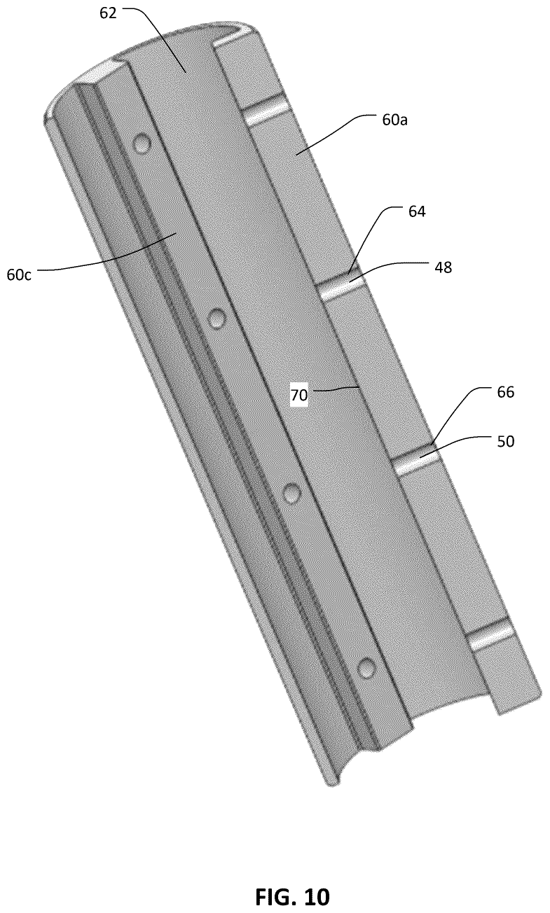

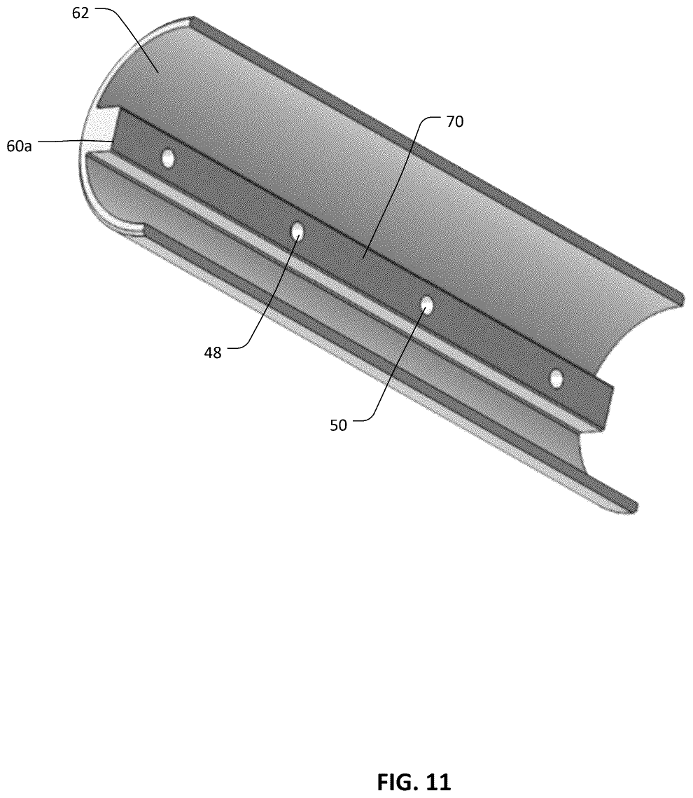

Turning now to FIGS. 1-11, a light pole assembly 10 includes a first pole shaft 20 having a first pole shaft wall 22 and a first opening 24 configured to receive a first fastener 26; a second pole shaft 30 having a second pole shaft wall 32 and a second opening 34 configured to receive a second fastener 36. A mounting connector 40 includes a connecting wall 42 having a first end 44 and a second end 46. The connecting wall 42 is symmetrical about a longitudinal axis A and includes a first connecting opening 48 configured to receive the first fastener 26 and a second connecting opening 50 configured to receive the second fastener 36.

A first longitudinal rib 60a extends from an inner surface 62 of the mounting connector 40 and along the longitudinal axis A of the mounting connector 40. The first longitudinal rib 60a extends across the first connecting opening 48 and the second connecting opening 50. The first connecting opening 48 and the second connecting opening 50 extend through the first longitudinal rib 60a, thereby forming a first through bore 64 that and a second through bore 66 that extend from an outer surface 68 of the connecting wall to an inner surface 70 of the first longitudinal rib 60a. The first through bore 64 and the second through bore 66 may comprise internal threads (not shown) to cooperate with external threads on the first fastener 26 and the second fastener 36.

The first pole shaft 20 and the second pole shaft 30 have substantially the same cross-sectional dimensions, and the mounting connector 40 has smaller cross-sectional dimensions at the first end 44 and at the second end 46 than the first pole shaft 20 and the second pole shaft 30 such that the first end 44 of the mounting connector 40 is sized to be inserted at least partially within the first pole shaft 20 and the second end 46 of the mounting connector 40 is sized to be inserted at least partially within the second pole shaft 30.

In the illustrated embodiment, the first pole shaft 20 and the second pole shaft 30 comprise hollow circular cylinders having substantially identical diameters. The mounting connector 40 also comprises a hollow circular cylinder having a diameter that is slightly smaller than the diameters of the first pole shaft 20 and the second pole shaft 30. In other embodiments, the first pole shaft and the second pole shaft may comprise other shapes, such as hollow square or rectangular cylinders. In such embodiments, the mounting connector 40 would also comprise a hollow square or rectangular cylinder with slightly smaller dimensions than the first pole shaft 20 and the second pole shaft 30.

The first fastener 26 extends at least partially through the first opening 24, through the first connecting opening 48, and at least partially through the first longitudinal rib 60a when the mounting connector 40 is attached to the first pole shaft 20, and the first fastener 26 draws the first longitudinal rib 60a (and thus the connecting wall 42) outward, towards the first pole shaft wall 22. Likewise, the second fastener 36 extends at least partially through the second opening 34, through the second connecting opening 50, and at least partially through the first longitudinal rib 60a when the mounting connector 40 is attached to the second pole shaft 30, and the second fastener 36 draws the first longitudinal rib 60a (and thus the connecting wall 42) outward, towards the second pole shaft wall 32.

In contrast to one traditional method of using a set screw to apply friction to an inner member (such as the mounting connector), the disclosed mounting connector 40 with a first longitudinal rib 60a provides a much larger area of contact between the mounting connector 40, the first pole shaft 20, and the second pole shaft 30. More specifically, when the first fastener 26 and the second fastener 36 are secured to the first longitudinal rib 60a, pulling axial forces from the first fastener 26 and the second fastener 36 draw the connecting wall 42 outward into contact with the first pole shaft wall 22 and the second pole shaft wall 32, thereby forming a large area of contact between the mounting connector 40, the first pole shaft 20, and the second pole shaft 30. In contrast, set screws contact a wall of an inner member and thereby apply pressure to the inner member, pushing it away from an outer member (such as a first or second pole shaft), which results in a very small footprint of increased pressure and friction (e.g., the end of the fastener against the inner member), and an overall weakened connection structure.

In some embodiments, a second longitudinal rib 60b extends from the inner surface 62 of the mounting connector 40 and along the longitudinal axis A of the mounting connector 40.

While not illustrated in FIGS. 1-11, in some embodiments, the first longitudinal rib 60a and the second longitudinal rib 60b may be separated by about 180 degrees around a perimeter of the connecting wall 42. In other words, the first longitudinal rib 60a and the second longitudinal rib 60b may oppose one another in the hollow center of the mounting connector 40.

In the embodiment illustrated in FIGS. 1-11, a third longitudinal rib 60c extends from the inner surface 62 of the mounting connector 40 and along the longitudinal axis A of the mounting connector 62. The first longitudinal rib 60a, the second longitudinal rib 60b, and the third longitudinal rib 60c are separated from one another by about 120 degrees around a perimeter of the connecting wall. In other embodiments, more longitudinal ribs may be added. Generally, the longitudinal ribs are approximately equally spaced from one another. Two and three longitudinal ribs in the spacing described above have been found to be particularly effective at damping vibrations in the assembled light pole assembly 10.

When multiple longitudinal ribs are employed, for example the second longitudinal rib 60b and the third longitudinal rib 60c, the longitudinal ribs may each comprise a plurality of openings or through bores 67, which are sized and shaped as the through bores 64, 66 of the first longitudinal rib 60a described above. Each opening or through bore 67 may be configured receive a fastener, such as the fasteners 26, 36 described above.

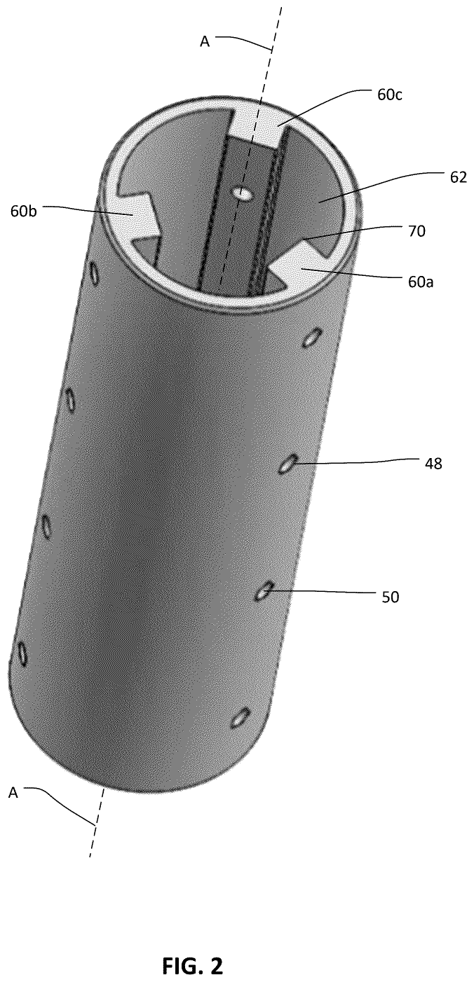

In the embodiment of FIGS. 1-11, the longitudinal ribs 60a, 60b, 60c, are integrally formed with the mounting connector 40 connecting wall 42. In the illustrated embodiment, the first longitudinal rib 60a, the second longitudinal rib 60b, and the third longitudinal rib 60c each have a thickness that is greater than a thickness of the connecting wall 42. See for example FIGS. 2-4. Having the thickness of the longitudinal ribs 60a, 60b, 60c greater than the thickness of the connecting wall 42 enhances the vibration damping effect of the mounting connector 40. However, in other embodiments, the longitudinal ribs 60a, 60b, 60c may have a thickness that is equal to, or less than, the thickness of the connecting wall 42. In addition to cooperating with the fasteners to draw the connecting wall 42 outwards, the longitudinal ribs 60a, 60b, 60c also structurally reinforce the mounting connector 40, which creates an increased rigidity of the connecting wall 42 that approximates that of a wall that is much thicker (e.g., as thick as the connecting wall 42 and the longitudinal ribs) while using less material.

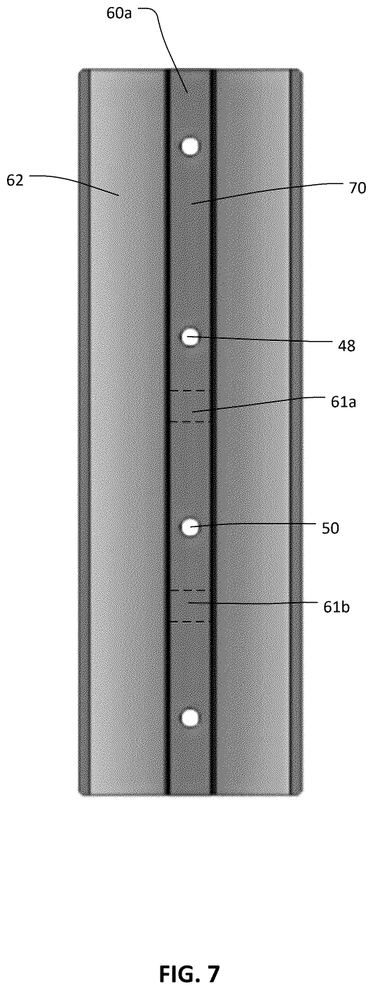

While the longitudinal ribs 60a, 60b, 60c are continuous from end to end in the embodiment of FIGS. 1-11, in other embodiments, the longitudinal ribs may be non-continuous (i.e., may include one or more breaks along a longitudinal dimension). For example, the first longitudinal rib 60a may be non-continuous (as illustrated by the dashed lines in FIG. 7), thereby including one or more breaks 61a, 61b, along the longitudinal axis A.

In the embodiment illustrated in FIGS. 1-11, the first pole shaft 20, the second pole shaft 30, and the mounting connector 40 each have substantially circular cross-sectional shapes. In other embodiments, the first pole shaft 20, the second pole shaft 40, and the mounting connector 40 may each have substantially square cross-sectional shapes.

Generally, the first pole shaft 20, the second pole shaft 30, and the mounting connector 40 may comprise a strong durable material, such as a metal, in particular, aluminum or steel. However, other embodiments may comprise other strong durable materials, such as ceramics, composites, plastics, etc.

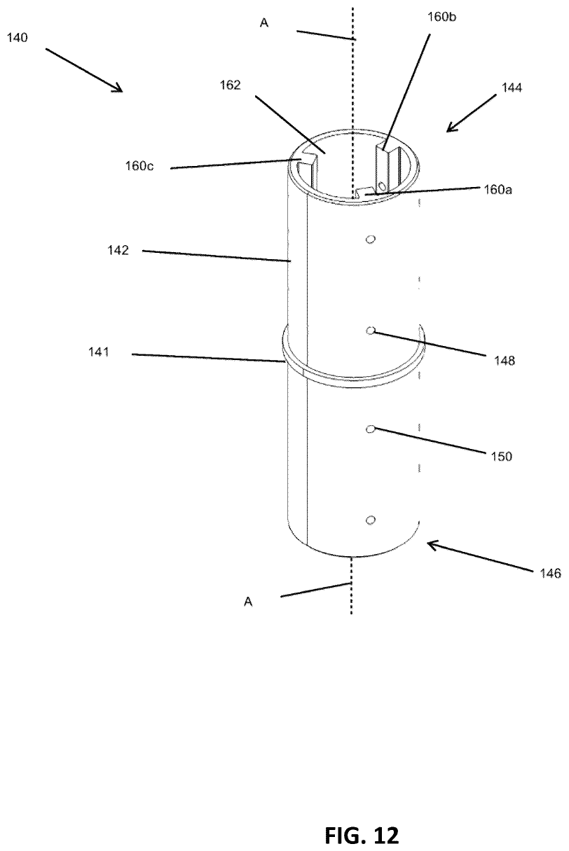

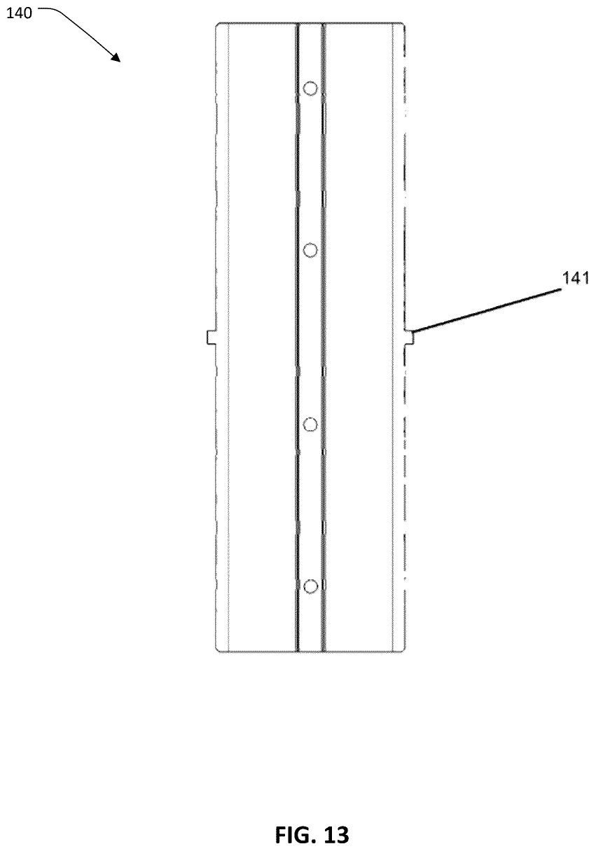

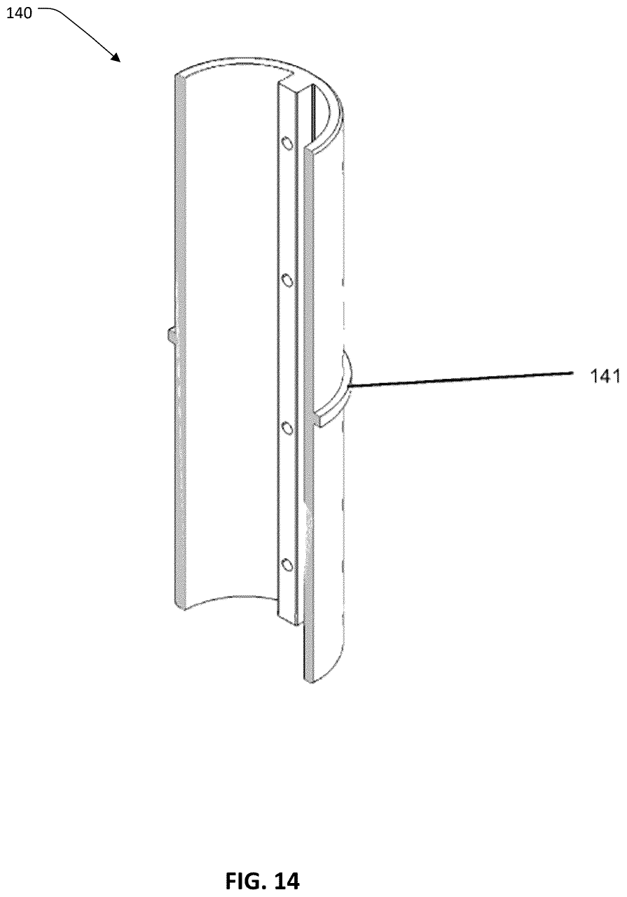

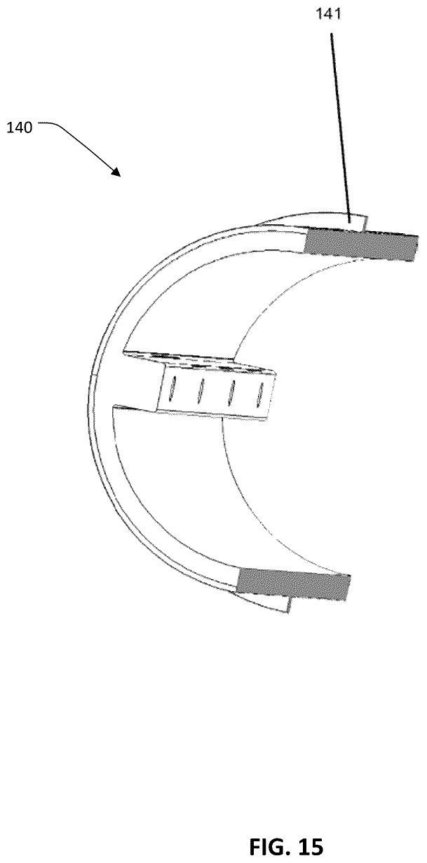

Turning now to FIGS. 12-15, a second embodiment of mounting connector 140 is illustrated. Any feature, structure, or function of the mounting connector 40 of FIGS. 1-11 may be added to, or replaced with, any feature, structure, or function of the mounting connector 140 described in FIGS. 12-15.

The mounting connector 140 may be used with first and second pole shafts, such as the first pole shaft 20 and the second pole shaft 30 illustrated in FIG. A. The mounting connector 140 includes a connecting wall 142 having a first end 144 and a second end 146. The connecting wall 142 is symmetrical about a longitudinal axis A and includes a first connecting opening 148 configured to receive a first fastener (not shown in FIGS. 12-15, but similar or identical to the fastener 48 of FIG. 1) and a second connecting opening 150 configured to receive a second fastener (not shown in FIGS. 12-15, but similar to or identical to the fastener 50 of FIG. 1).

A first longitudinal rib 160a extends from an inner surface 162 of the mounting connector 140 and along the longitudinal axis A of the mounting connector 140. The first longitudinal rib 160a extends across the first connecting opening 148 and the second connecting opening 150. A second longitudinal rib 160b and a third longitudinal rib 160c may also extend from the inner surface 162 of the mounting connector 140 along the longitudinal axis A.

The mounting connector 140 of FIGS. 12-15 differs from the mounting connector 40 of FIGS. 1-11, in that the mounting connector 140 of FIGS. 12-15 includes an exterior ledge 141 that extends outward from an outer surface 168 of the connecting wall 142. The exterior ledge 141 may have a thickness that is approximately equal to a thickness of a wall of the first pole shaft and/or the second pole shaft. The exterior ledge 141 forms a stop that locates the end of the first pole shaft and the second pole shaft when the first pole shaft and the second pole shaft are connected to one another by the mounting connector 140. The exterior ledge 141, due to its thickness being approximately equal to the thickness of the walls of the first and second pole shafts, forms a smooth outer transition between the first pole shaft and the second pole shaft. The exterior ledge 141 is positioned approximately half way between the first end 144 of the mounting connector 140 and the second end 146 of the mounting connector 140.

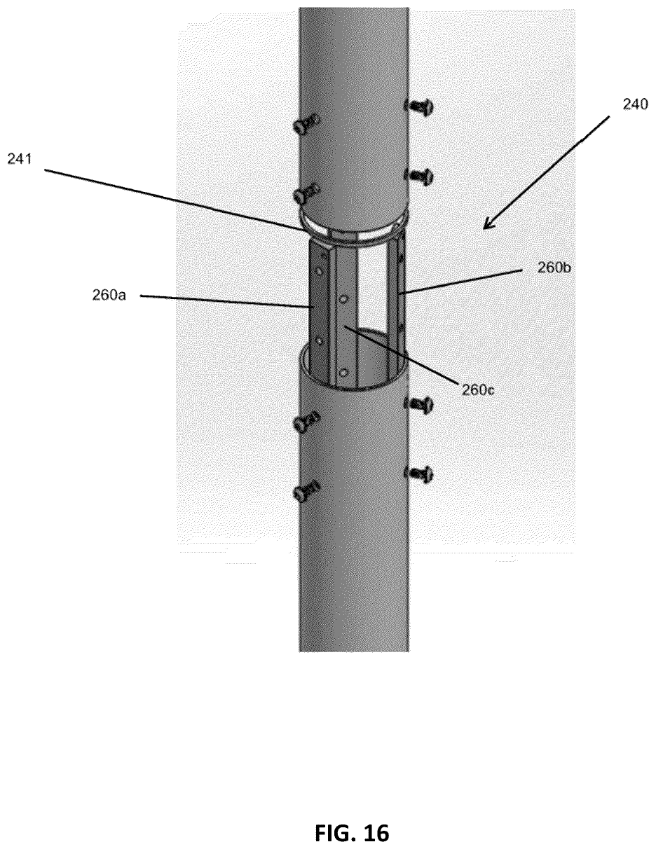

FIG. 16 illustrates another embodiment of a mounting connector structure 240. In the embodiment of FIG. 16, the mounting connector structure 240 includes a spacer ring 241, a first longitudinal rib 260a, a second longitudinal rib 260b, and a third longitudinal rib 206c. The mounting connector structure 240 of FIG. 16 differs from the mounting connector 40 and the mounting connector 140 above in that the mounting connector structure 240 does not have a connecting wall.

Returning now to FIGS. 1-11, a method for assembling a light pole assembly includes providing a first pole shaft 20 having a first pole shaft wall 22 and a first opening 24 configured to receive a first fastener 26; providing a second pole shaft 30 having a second pole shaft wall 32 and a second opening 34 configured to receive a second fastener 36; and providing a mounting connector 40 including a connecting wall 42 having a first end 44 and a second end 46, the connecting wall 42 being symmetrical about a longitudinal axis A. The connecting wall 42 includes a first connecting opening 48 configured to receive the first fastener 26 and a second connecting opening 50 configured to receive the second fastener 36. The mounting connector 40 further includes a first longitudinal rib 60a extending from an inner surface 62 of the mounting connector 40 and along the longitudinal axis A of the mounting connector 40. The first longitudinal rib 60a extends across the first connecting opening 48 and the second connecting opening 50. The first connecting opening 48 and the second connecting opening 50 extend through the first longitudinal rib 60a, thereby forming a first through bore 64 that extends from an outer surface 68 of the connecting wall 42 to an inner surface 70 of the first longitudinal rib 60a. A first end 44 of the mounting connector 40 is at least partially inserted into an open end of the first pole shaft 20. A second end 46 of the mounting connector 40 is at least partially inserted into an open end of the second pole shaft 30. A first fastener 26 is inserted through the first opening 24, through the first connecting opening 48, and at least partially through the first longitudinal rib 60a. A second fastener 36 is inserted through the second opening 34, through the second connecting opening 50, and through the first longitudinal rib 60a. The first and second fasteners 26, 36 are tightened to secure the mounting connector 40 to the first and second pole shafts 20, 30.

In some optional embodiments, the light pole assembly 10 may optionally include a plurality of first pole shafts 20 and a plurality of second pole shafts 30, and a plurality of mounting connectors 40. In some optional embodiments, the light pole assembly 10 may optionally include between two and five total first and second pole shafts 20, 30. Each pole shaft 20, 30 may have a length of approximately 4 ft (1.22 m) for a total light pole assembly 10 length of between 8 ft (2.44 m) and 20 ft (6.1 m). The second pole shaft 30 may include a mounting flange for securing the light pole to a surface, such as a paved surface or a ground surface. In some embodiments, the mounting connector 40 comprises a connecting wall length of between 3.6 in (9.1 cm) and 3.9 in (9.9 cm), preferably between 3.7 in (9.4 cm) and 3.8 in (9.65 cm), and more preferably approximately 3.74 in (9.5 cm).

In some embodiments, the mounting connector 40 may further include an internal shelf having a shelf opening. The shelf opening 78 may be circular, although other embodiments may have other shaped openings. The internal shelf may add additional rigidity to the overall mounting connector 40 structure and the shelf opening allows electrical connections to be passed through the open center of the assembled light pole. The internal shelf 76 may comprise a flat rectangular (square) platform with a circular opening therein. In other embodiments, the internal shelf may take other forms, such as a plurality of studs, ribs, ridges, prongs, castellations, detents, or other inwardly-directed projections.

A benefit of the assembly and method of the present disclosure is that the ability to utilize relatively short pole shafts in the assembly of a light pole is found to result in light poles having greater overall sturdiness and stability, with reduced deflection and vibration, even in high wind-prone locations.

While various embodiments have been described herein, it will be understood that modifications may be made thereto that are still considered within the scope of the appended claims.

What is claimed is:

1. A light pole assembly comprising:
a first pole shaft having a first pole shaft wall and a first opening configured to receive a first fastener;
a second pole shaft having a second pole shaft wall and a second opening configured to receive a second fastener;
a mounting connector including a connecting wall having a first end and a second end, the connecting wall being symmetrical about a longitudinal axis, the connecting wall including a first connecting opening configured to receive the first fastener and a second connecting opening configured to receive the second fastener; and
a first longitudinal rib extending from an inner surface of the mounting connector and along the longitudinal axis of the mounting connector, the first longitudinal rib extending across the first connecting opening and the second connecting opening, the first connecting opening and the second connecting opening extending through the first longitudinal rib, thereby forming a first through bore that extends from an outer surface of the connecting wall to an inner surface of the first longitudinal rib,
wherein the first pole shaft and the second pole shaft have substantially the same cross-sectional dimensions, and the mounting connector has smaller cross-sectional dimensions at the first end and at the second end than the first pole shaft and the second pole shaft such that the first end of the mounting connector is sized to be inserted at least partially within the first pole shaft and the second end of the mounting connector is sized to be inserted at least partially within the second pole shaft.

2. The light pole assembly of claim 1, further comprising the first fastener extending at least partially through the first opening, through the first connecting opening, and through the first longitudinal rib.

3. The light pole assembly of claim 1, further comprising a second fastener extending at least partially through the second opening, through the second connecting opening, and through the first longitudinal rib.

4. The light pole assembly of claim 1, further comprising a second longitudinal rib.

5. The light pole assembly of claim 4, wherein the first longitudinal rib and the second longitudinal rib are separated by about 180 degrees around a perimeter of the connecting wall.

6. The light pole assembly of claim 4, further comprising a third longitudinal rib,
wherein the first longitudinal rib, the second longitudinal rib, and the third longitudinal rib are separated from one another by about 120 degrees around a perimeter of the connecting wall.

7. The light pole assembly of claim 6, wherein the second longitudinal rib and the third longitudinal rib each define a plurality of openings each opening the plurality of openings being configured to receive a fastener.

8. The light pole assembly of claim 1, wherein the first longitudinal rib has a thickness that is greater than a thickness of the connecting wall.

9. The light pole assembly of claim 1, wherein the first longitudinal rib is not continuous and includes one or more breaks therein along the longitudinal axis.

10. The light pole assembly of claim 1, wherein the first pole shaft, the second pole shaft, and the mounting connector each have substantially circular cross-sectional shapes.

11. The light pole assembly of claim 1, wherein the first pole shaft, the second pole shaft, and the mounting connector each comprise aluminum.

12. The light pole assembly of claim 1, wherein an exterior ledge extends outward from an outer surface of the connecting wall and has a thickness that is less than a width of the connecting wall.

13. The light pole assembly of claim 12, wherein the ledge is positioned approximately half way between the first end of the mounting connector and the second end of the mounting connector.

14. A method for assembling a light pole assembly, the method comprising:
providing a first pole shaft having a first pole shaft wall and a first opening configured to receive a first fastener;
providing a second pole shaft having a second pole shaft wall and a second opening configured to receive a second fastener;
providing a mounting connector including a connecting wall having a first end and a second end, the connecting wall being symmetrical about a longitudinal axis, the connecting wall including a first connecting opening configured to receive the first fastener and a second connecting opening configured to receive the second fastener, the mounting connector further including a first longitudinal rib extending from an inner surface of the mounting connector and along the longitudinal axis of the mounting connector, the first longitudinal rib extending across the first connecting opening and the second connecting opening, the first connecting opening and the second connecting opening extending through the first longitudinal rib, thereby forming a first through bore that extends from an outer surface of the connecting wall to an inner surface of the first longitudinal rib;
at least partially inserting a first end of the mounting connector into an open end of the first pole shaft;
at least partially inserting a second end of the mounting connector into an open end of the second pole shaft;
inserting a first fastener through the first opening, through the first connecting opening, and through the first longitudinal rib; and
inserting a second fastener through the second opening, through the second connecting opening, and through the first longitudinal rib.

15. The method of claim 14, further comprising a third longitudinal rib.

16. The method of claim 15, wherein the first longitudinal rib, the second longitudinal rib, and the third longitudinal rib are separated from one another by about 120 degrees around a perimeter of the connecting wall.

17. The method of claim 15, wherein the second longitudinal rib and the third longitudinal rib each define a plurality of openings each opening the plurality of openings being configured to receive a fastener.

18. The method of claim 14, wherein the first longitudinal rib has a thickness that is greater than a thickness of the connecting wall.

19. The method of claim 14, further comprising inserting the first end of the mounting connector into the open end of the first pole shaft until an external ledge on the mounting connector contacts the open end of the first pole shaft.

20. The method of claim 19, further comprising inserting the second end of the mounting connector into the open end of the second pole shaft until the external ledge on the mounting connector contacts the open end of the second pole shaft.
